(19) United States
(12) Patent Application Publication
(10) Pub. No.: US 2006/0279683 A1
(43) Pub. Date: Dec. 14, 2006

(54) Fringe field switching mode LCD having high transmittance

(75) Inventors: Jun Baek Park, Kyoungki-do (KR); Hyang Yul Kim, Kyoungki-do (KR); Youn Hak Jeong, Kyoungki-do (KR)

Correspondence Address: SEYFARTH SHAW LLP, 131 S. DEARBORN ST., SUITE2400, CHICAGO, IL, 60603-5803, US

(73) Assignee: Boe Hydis Technology Co., Ltd.

(21) Appl. No.: 11/207,652

(22) Filed: Aug. 18, 2005

(30) Foreign Application Priority Data
Jun. 14, 2005 (KR) 10-2005-0050823

(51) Int. Cl. G02F 1/1343

(52) U.S. Cl. 349/141

(57) ABSTRACT

A fringe field switching mode LCD includes a lower substrate having a gate bus line and a data bus line arranged to cross each other and form unit pixels and a counter electrode and a pixel electrode positioned within each unit pixel region with a gate insulator interposed between them and an upper substrate provided with a color filter corresponding to each pixel region and bonded to the lower substrate with a liquid crystal layer interposed between them. The pixel electrode includes first pixel electrodes positioned on the gate insulator and second pixel electrodes positioned on a protective layer, which is interposed between the first and second pixel electrodes, with a predetermined horizontal spacing from the respective first pixel electrodes and electrically connected to the first pixel electrodes via contact holes formed on the protective layer.

### BACKGROUND OF THE INVENTION

1. Field of the Invention

The present invention relates to a fringe field switching mode LCD, and more particularly to a fringe field switching mode LCD having a high transmittance.

2. Description of the Prior Art

A fringe field switching mode (hereinafter, referred to as FFS-mode) LCD has been proposed to improved the low aperture ratio and transmittance of in-plane switching mode (hereinafter, referred to as IPS-mode) LCDs, as disclosed in Registered Korean Patent No. 10-0341123.

The FFS-mode LCD has a counter electrode and a pixel electrode made of a transparent conductor for higher aperture ratio and-transmittance than the IPS-mode LCD. In addition, the spacing between the counter electrode and the pixel electrode is smaller than that between upper and lower glass substrates, so that a fringe field is established between the counter electrode and the pixel electrode and even the liquid crystal molecules existing on top of the electrodes are operated to improve the transmittance.

FIG. 1 is a sectional view showing briefly the array of a conventional FFS-mode LCD.

Referring to the drawing, the FFS-mode LCD has an array constructed as follows: a gate insulator 20 and a protective layer 30 are successively laminated on a counter electrode 10 and pixel electrodes 40 are positioned on the protective layer 30 with a predetermined spacing.

The pixel electrodes 40 have a width w of 3 μm and the spacing l′ between them is 5 μm. In this case, w/l′=3/5.

FIG. 2 shows another example wherein the width of the pixel electrodes 40 remains unchanged and the spacing between them is varied to 3 μm (i.e., the same as the width). In this case, w/l′=3/3.

In FIGS. 1 and 2, arrow a indicates the center of a pixel electrode 40, arrow b indicates a position spaced about 0.5 μm from the pixel electrode 40, and arrow c indicates the middle position between pixel electrodes 40.

When the value of l′ varies while that of w remains the same, the driving voltage and the maximum transmittance increase as the value of l′ decreases, as shown in FIG. 3. FIG. 3 also shows a case wherein w/l′=3/8 for reference.

FIG. 4 shows the relationship between the driving voltage and the transmittance in positions a and b when the value of l′ varies while that of w remains the same. FIG. 4 also shows a case wherein w/l′=3/8 for reference.

It is clear from FIG. 4 that, in the case of w/l′=3.5, the difference in driving voltage between positions a and b is about 0.8V and to acquire simultaneously the maximum transmittance in both positions a and b is impossible. In the case of w/l′=3/3, the overall driving voltage increases. However, the difference in driving voltage between positions a and b is substantially smaller than in the case of w/l′=3/5 and the maximum transmittance in position a and b can be almost achieved, respectively.

The above data shows that, when the value of l′ decreases while that of w remains the same, the driving voltage and the average overall transmittance increase.

However, any attempt to reduce the value of l′ for an increased average overall transmittance is impractical, due to vulnerability of the value of l′ in actual processes, and is uneconomical.

### SUMMARY OF THE INVENTION

Accordingly, the present invention has been made to solve the above-mentioned problems occurring in the prior art, and an object of the present invention is to provide a fringe field switching mode LCD having pixel electrodes positioned to easily increase the overall transmittance.

In order to accomplish this object, there is provided a fringe field switching mode LCD including a lower substrate having a gate bus line and a data bus line arranged to cross each other and form unit pixels and a counter electrode and a pixel electrode positioned within each unit pixel region with a gate insulator interposed between them and an upper substrate provided with a color filter corresponding to each pixel region and bonded to the lower substrate with a liquid crystal layer interposed between them, wherein the pixel electrode includes first pixel electrodes positioned on the gate insulator and second pixel electrodes positioned on a protective layer, which is interposed between the first and second pixel electrodes, with a predetermined horizontal spacing from the respective first pixel electrodes and electrically connected to the first pixel electrodes via contact holes formed on the protective layer.

The vertical spacing between the first and second pixel electrodes is preferably 1,000-3,000Å.

The protective layer is preferably made of any material chosen from a group comprising resin and inorganic insulator.

The first and second pixel electrodes preferably have the same width of less than 5 μm.

Preferably, the distance between the first pixel electrodes is the same as that between the second pixel electrodes and is the sum of the width of the first and second pixel electrodes and twice the spacing between the respective first and second pixel electrodes.

Preferably, the horizontal spacing is less than 5 μm.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view showing briefly the array of a conventional FFS-mode LCD;

FIG. 2 is a sectional view showing briefly the array of another conventional FFS-mode LCD;

FIG. 3 is a graph showing the relationship between the driving voltage and the transmittance in the middle position between pixel electrodes of the FFS-mode LCDs shown in FIGS. 1 and 2;

FIG. 4 is a graph showing the relationship between the driving voltage and the transmittance in the center position of a pixel electrode, as well as in a position spaced a predetermined distance from electrode edge, of the FFS-mode LCDs shown in FIGS. 1 and 2;

FIG. 5 is a sectional view showing briefly the array of an FFS-mode LCD according to an embodiment of the present invention; and

FIG. 6 is a graph showing the relationship between the voltage and the averaged transmittance of the FFS-mode LCDs shown in FIGS. 1, 2, and 5.

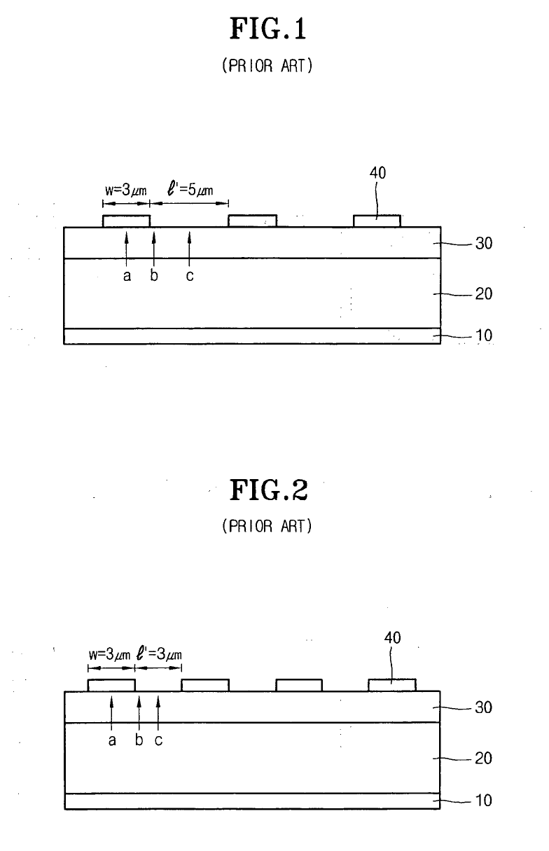

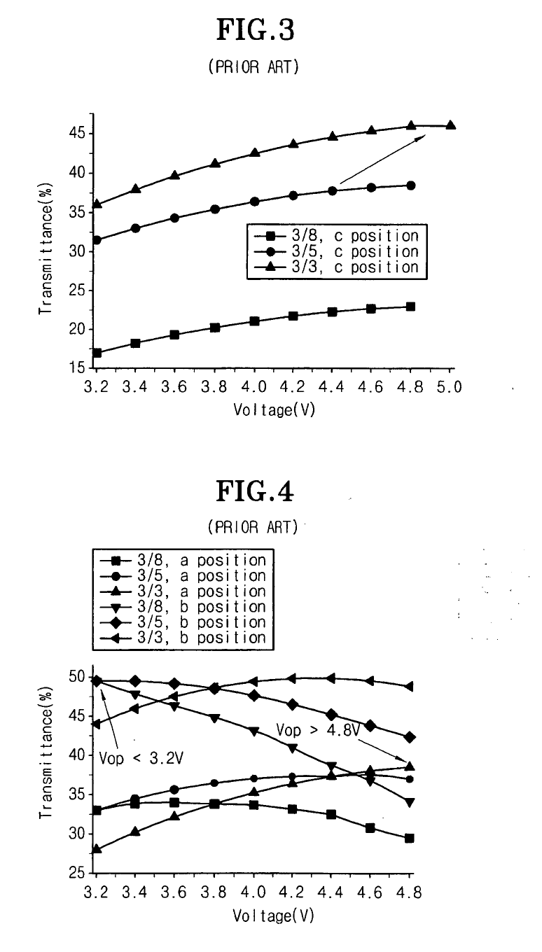

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

An FFS-mode LCD includes a lower substrate having a gate bus line and a data bus line arranged to cross each other and form unit pixels, as well as a counter electrode and a pixel electrode positioned in each unit pixel region with a gate insulator interposed between them and an upper substrate having a color filter corresponding to each pixel region and bonded to the lower substrate with a liquid crystal layer interposed between them. The construction of the FFS-mode LCD is widely known in the art and will not be shown in detail in the drawing for clarity.

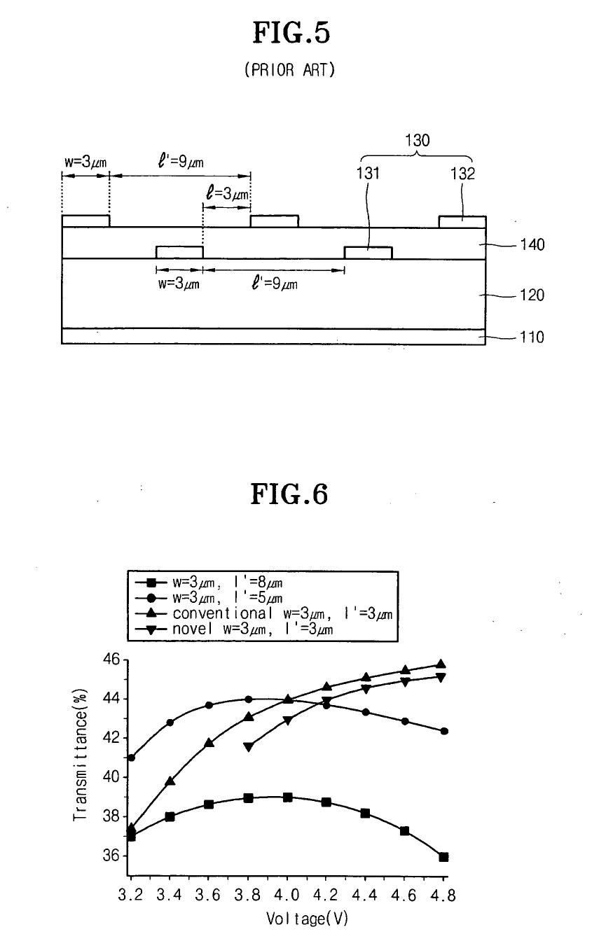

FIG. 5 is a sectional view showing briefly the array of an FFS-mode LCD according to an embodiment of the present invention.

Referring to the drawing, the array of the FFS-mode LCD is constructed as follows: a gate insulator 120 is laminated on a counter electrode 110. First pixel electrodes 131 are provided on the gate insulator 120 and a protective layer 140 is laminated on the gate insulator 120 to cover the first pixel electrodes 131. Second pixel electrodes 132 are provided on the protective layer 140 and are connected to the source (not shown) and the drain (not shown) via contact holes (not shown) formed on the protective layer 140. The second pixel electrodes 132 are connected to the first pixel electrodes 131 and can be driven by a single driving device (TFT).

The vertical spacing between the first and second pixel electrodes 131 and 132 is 1,000-3,000Å. In order to maintain this spacing, the protective layer 140 is formed by depositing resin or inorganic insulator.

The first and second pixel electrodes 131 and 132 have the same width w of less than 5 μm (for example, 3 μm in the present embodiment).

The first and second pixel electrodes 131 and 132 are positioned on the gate insulator 110 and the protective layer 140 with a predetermined spacing between them, respectively. The spacing l′ is equal to the sum of the width of the first and second pixel electrodes 131 and 132 and twice the horizontal distance l between the first and second pixel electrodes 131 and 132. This relation can be expressed as l′=w+21.

The horizontal distance between the first and second pixel electrodes 131 and 132 is less than 5 μm (for example, 3 μm in the present embodiment).

As the first and second pixel electrodes 131 and 132 alternate with a predetermined distance in the horizontal direction with the protective layer 140 interposed between them, pixel electrodes 130 of w/l′=3/3 are provided to improve the transmittance.

It is difficult to manufacture pixel electrodes 130 of w/l′=3/3 in conventional processes. However, the present invention has overcome this problem and improved the transmittance by form first pixel electrodes 131 of w/l′=3/9on the gate insulator 120 and second pixel electrode 132 of w/l′=3/9 on the protective layer 140 while alternating with the first pixel electrodes 131. In addition, the pixel electrodes 130 may be formed on a number of layers in this method to further reduce the value of l′.

FIG. 6 shows the comparison of the driving voltage and the transmittance between the present invention and the prior art. It is clear from the drawing that the present invention has a transmittance similar to that of the prior art when w/′l=3/3 and higher than when w/l′=3/5.

The inventive pixel electrodes are adapted to realize w/l′=3/3 to improve the transmittance and are also suitable for more precise structures.

As mentioned above, the fringe field switching mode LCD according to the present invention has pixel electrodes alternating on each of two layers vertically laminated on each other and the horizontal distance between the pixel electrodes positioned on the upper and lower layers is reduced to improve the transmittance.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A fringe field switching mode LCD comprising:
a lower substrate having a gate bus line and a data bus line arranged to cross each other and form unit pixels and a counter electrode and a pixel electrode positioned within each unit pixel region with a gate insulator interposed between them and
an upper substrate provided with a color filter corresponding to each pixel region and bonded to the lower substrate with a liquid crystal layer interposed between them, wherein the pixel electrode comprises:
first pixel electrodes positioned on the gate insulator and
second pixel electrodes positioned on a protective layer, which is interposed between the first and second pixel electrodes, with a predetermined horizontal spacing from the respective first pixel electrodes and electrically connected to the first pixel electrodes via contact holes formed on the protective layer.

2. The fringe field switching mode LCD as claimed in claim 1, wherein the vertical spacing between the first and second pixel electrodes is 1,000-3,000Å.

3. The fringe field switching mode LCD as claimed in claim 1, wherein the protective layer is made of any material chosen from a group comprising resin and inorganic insulator.

4. The fringe field switching mode LCD as claimed in claim 1, wherein the first and second pixel electrodes have the same width of less than 5 μm.

5. The fringe field switching mode LCD as claimed in claim 1, wherein the distance between the first pixel electrodes is the same as that between the second pixel electrodes and is the sum of the width of the first and second pixel electrodes and twice the spacing between the respective first and second pixel electrodes.

6. The fringe field switching mode LCD as claimed in claim 1, wherein the horizontal spacing is less than 5 μm.
